(19) United States
(12) Patent Application Publication
(10) Pub. No.: US 2023/0089807 A1
(43) Pub. Date: Mar. 23, 2023

(54) Odor-Resistant Food Storage Container

(71) Applicant: Shakila Kendall, Wilmington, DE (US)

(72) Inventor: Shakila Kendall, Wilmington, DE (US)

(21) Appl. No.: 17/851,086

(22) Filed: Jun. 28, 2022

Related U.S. Application Data
(60) Provisional application No. 63/246,351, filed on Sep. 21, 2021.

(51) Int. Cl. B65D 51/28; B01D 53/04; B65D 81/20

(52) U.S. Cl. CPC B65D 51/28; B01D 53/0407; B65D 81/2076; B01D 2253/102; B01D 2257/708; B01D 2257/90; B01D 2259/4525; B01D 2259/455; B65D 2543/00203; B65D 2543/00231; B65D 2543/00842

(57) ABSTRACT

The present invention relates to a reusable food storage container designed to store food items while preventing the odor of stored food from being retained in the container material. The container has a base comprised of odor-resistant material, such as stainless steel or glass, and has a lid with an embedded replaceable charcoal filter. The charcoal filter is configured to absorb odor emanating from stored food items. The container can comprise different sizes, designs, shapes, and colors and can be washed and reused. In one embodiment, a lid of the container has a cavity for embedding the charcoal filter, and in another embodiment, the bottom surface of the lid has a frame with a continuous channel for accommodating the charcoal filter. The lid is configured to seal the stored food material using a skirt wall for preserving the food items.

### CROSS-REFERENCE TO RELATED APPLICATION

The present application claims priority to, and the benefit of, U.S. Provisional Application No. 63/246,351, which was filed on Sep. 21, 2021 and is incorporated herein by reference in its entirety.

### FIELD OF THE INVENTION

The present invention relates generally to the field of food storage containers. More specifically, the present invention relates to a novel food storage container that does not retain odor of stored food items and is configured to be reused without worry of previous food odors emanating from the container or the container becoming stained. The container utilizes odor-resistant material and a charcoal absorbent filter, that functions in conjunction with each other, for preventing stored food odors from being retained in the container material. Accordingly, the present disclosure makes specific reference thereto. Nonetheless, it is to be appreciated that aspects of the present invention are also equally applicable to other like applications, devices, and methods of manufacture.

### BACKGROUND

By way of background, various kinds of containers or storage devices are used by individuals for storing leftover food. Generally, plastic storage containers are used for leftover food, however, these containers may get stained easily with the food kept inside and may retain odors from food previously stored within it. Some stains can be stubborn and may not be washed even with multiple washing of the containers. Also, some food odors may also not go away even after cleaning the containers with different cleaning solutions. Some individuals keep their leftover food inside food wrap (i.e., aluminum foil) in order to prevent the odor of the leftover food from passing to the container. However, liquid food items may not be kept inside food wrap and may pass their odors to the container. Also, standard foil does not completely prevent odor of the leftover food from passing outside the foil and may eventually affect the container. Different cleaning solutions also claim to effectively clean the containers without leaving any stains and odors, however, heretofore known cleaning solutions fail to properly remove stains and odors from the containers. Currently, no appropriate solution exists to eliminate stubborn stains and strong odors of containers used to store leftover food items.

With such stubborn stains and strong odors, individuals may be forced to frequently throw away the containers. This causes individuals to buy new containers frequently in order to keep leftover food items. Individuals desire food storage containers that minimize expenses and improves the storage of food.

Additionally, with conventional plastic storage containers, the food kept inside may not stay fresh for extended periods of time and is ultimately thrown away and wasted. These containers fail to store leftover food items for extended periods of time while ensuring that the containers remain fresh for subsequent uses. Therefore, the standard plastic storage containers available in the market fail to serve the purpose of effectively storing leftover food items.

Therefore, there exists a long-felt need in the art for a container that keeps leftover food fresh for a long period of time. There is also a long-felt need in the art for a storage container that prohibits the container from acquiring stubborn stains and allows it to be washed easily with any cleaning solution. Additionally, there is a long-felt need in the art for a food storage container that prevents leftover food from becoming quickly spoiled and ensures the food remains fresh for extended periods of time. There is a long-felt need in the art for a container that prevents leftover food from being thrown away and wasted. Moreover, there is a long-felt need in the art for a storage container that prevents the odor of leftover food items from being retained inside the container. Further, there is a long-felt need in the art for a food storage container that prevents the users from frequently throwing away containers and buying new ones. Finally, there is a long-felt need in the art for a food storage container that can be quickly and easily washed and reused without worry of previous food odors emanating from the container.

The subject matter disclosed and claimed herein, in one embodiment thereof, comprises a multipurpose odor-resistant food storage container system. The food storage container is configured to be washed and reused without worry of previous food odors emanating from the container. The container, further comprising an odor-resistant main body having a bottom surface and a continuous sidewall extending upwards from the periphery of the bottom surface; the main body is configured to store food items, such as leftover food items therein; a lid configured to seal the stored food by positioning onto a top edge of the sidewall; wherein the lid has an embedded charcoal filter containing active carbon for absorbing odor emanating from the stored food item.

In this manner, the odor-resistant food storage container of the present invention accomplishes all of the foregoing objectives and provides users with an improved storage container for leftover food items that utilizes odor-resistant material and a charcoal absorbent filter for preventing food odor from being retained in the container material. The container can be washed and reused without worry of previous food odors emanating from the container thereby providing a more convenient and effective storage container for any type of food.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a multipurpose odor-resistant food storage container. The food storage container, further comprising a main body having a bottom surface and a continuous sidewall extending upwards from the periphery of the bottom surface; the main body is configured to store food items therein; a lid configured to seal the stored food by positioning onto or around a top edge of the sidewall; wherein the lid has an embedded charcoal filter for absorbing odor emanating from the stored food item; and, the main body is made from an odor-resistant stainless steel or glass material.

In yet another embodiment, a food storage container is disclosed. The food storage container includes a base made of odor-resistant food grade material; the base is configured to store food items therein; a lid having a skirt wall for creating a seal with the base to protect the stored food items; the lid having a cavity covered by a panel wherein the cavity is configured to store the charcoal filter; the charcoal filter absorbs the odor of the food items and is removably stored in the cavity.

In yet another embodiment, the lid has flange protrusions extending outward from the skirt wall for pulling the lid to open the seal and access the stored food items.

In yet another embodiment, a food storage container for leftover foods and other items is disclosed. The container includes a base, having a bottom surface and a continuous sidewall extending upwards from the base; the base is configured to store leftover food items; the base is made from odor-resistant material for preventing the odor of the leftover food items from being retained or absorbed in the base; a lid having a frame embedded on a bottom surface thereof; the frame having a continuous channel for accommodating a planar charcoal filter wherein the filter absorbs the odor of the stored food items and prohibits the odor from being retained inside the container.

In yet another embodiment, the charcoal filter is removably secured to the frame.

In yet another embodiment, the charcoal filter has active carbon configured to absorb ethylene gas.

In yet another embodiment, the container is in any geometric shape.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates an exploded view of one potential embodiment of a multipurpose reusable food storage container of the present invention in accordance with the disclosed architecture;

FIG. 2 illustrates a perspective view of the food storage container of FIG. 1 in accordance with the disclosed architecture;

FIG. 3 illustrates a bottom perspective view of another embodiment of the lid used in the food storage container in accordance with the disclosed architecture;

FIG. 4 illustrates a perspective view of the food storage container of FIG. 1 storing food in a refrigerator in accordance with the disclosed architecture;

FIG. 5 illustrates the food container of FIG. 1 being washed by a user for reuse in accordance with the disclosed architecture; and

FIG. 6 illustrates a perspective view showing different embodiments of the food storage container of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a container that keeps food fresh for a long period of time. There is also a long-felt need in the art for a storage container that prohibits the container from acquiring stubborn stains and allows it to be washed easily with any cleaning solution. Additionally, there is a long-felt need in the art for a food storage container that prevents the leftover food from becoming quickly spoiled and ensures the food remains fresh for extended periods of time. There is a long-felt need in the art for a container that prevents the leftover food from being thrown away and wasted. Moreover, there is a long-felt need in the art for a food storage container that prevents the odor of leftover food items from being retained inside the container. Further, there is a long-felt need in the art for a food storage container that prevents users from frequently throwing away containers and buying new ones. Finally, there is a long-felt need in the art for a food storage container that can be quickly and easily washed and reused without worry of previous food odors emanating from the container.

The present invention, in one exemplary embodiment, an odor-resistant food storage container for leftover foods and other items is disclosed. The container includes a base having a bottom surface and a continuous sidewall extending upward from the base; the base is configured to store leftover food items; the base is made from odor-resistant material for preventing the odor of the leftover food items from being retained in the base; a lid having a frame embedded on a bottom surface thereof; the frame having a continuous channel for accommodating a planar charcoal filter, wherein the filter absorbs the odor of the stored food items and prohibits the odor from being retained inside the container.

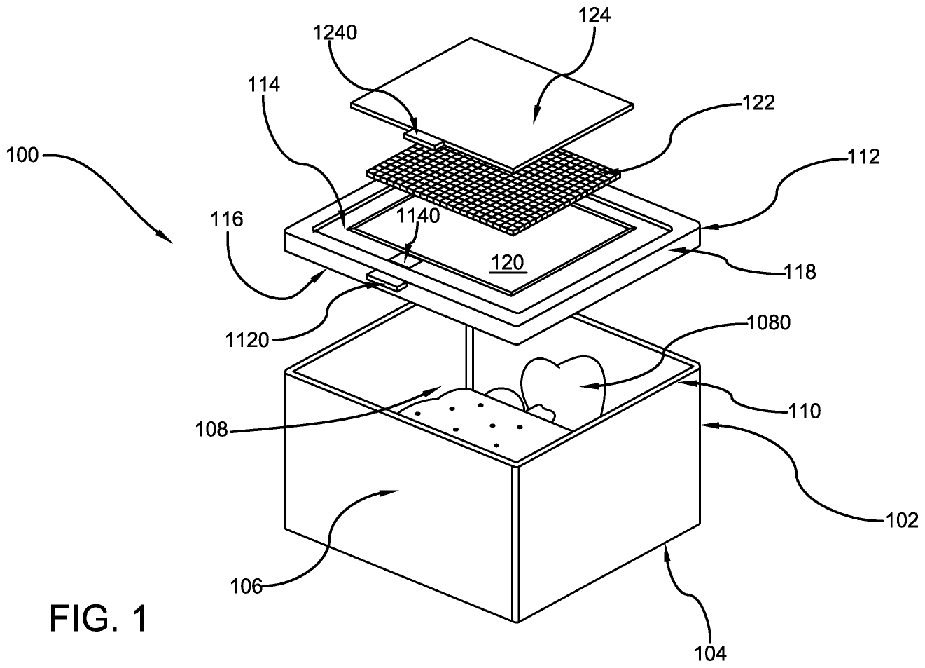

Referring initially to the drawings, FIG. 1 illustrates an exploded view of one potential embodiment of a multipurpose reusable food storage container of the present invention in accordance with the disclosed architecture. The multipurpose storage container 100 of the present invention is designed for storing food items, especially leftover food items. The container 100 generally has a base/main body 102 having a bottom surface 104 and a circumferential continuous sidewall 106. The sidewall 106 and the bottom surface 104 form an interior space 108 for storing food items 1080 therein. The sidewall 106 extends upwardly from a perimeter of the bottom surface 104 and terminates at a top edge 110. In the present embodiment, the illustrated sidewall 106 has a four-sided shape, however the sidewall 106 can have any other shape, such as a rounded shape and more as illustrated in other embodiments of the present invention.

The base 102 is preferably made of an odor-resistant material for prohibiting the odor of stored food items from being retained in the base 102. In one exemplary embodiment, the base 102 is made from food grade stainless steel, which is odor resistant and the flavors and smells from stored food item do not penetrate the base 102. In an alternative embodiment, the base 102 is made from glass which is both odor-resistant and oven-safe. The glass material is toughened and may be high-grade UV glass for protecting stored food from harmful light and heat.

A lid 112 is configured to cover the interior space 108 of the base 102 by creating a seal with the top edge 110 of the base 102. The lid 112 has a top surface 114 and a bottom surface 116 with a skirt wall 118 for sealing the interior space 108 of the base 102. A cavity 120 is disposed in the lid 112 for storing a charcoal filter 122 wherein the charcoal filter 122 is covered by a top panel 124. The top panel 124 is configured to be removably placed on the cavity 120 to cover the charcoal filter 122, the charcoal filter 122 is configured to remove volatile organic compounds (VOCs) and odors from the container 100 when the food is stored in the container 100. The charcoal filter 122 used in the lid 112 is configured to have a bed of activated carbon that absorbs odor and thereby prohibits the odor of food items to emanate from the container 100. The top panel 124 has a tab 1240 that is designed to engage with an opening 1140 in the lid for removably fastening to the lid 112. The skirt wall 118 creates a seal between the lid 112 and the base 102 to close off the interior space 108 and thus helps in preserving the food. The lid 112 has a plurality of flange protrusions 1120 for allowing a user to pull the lid 112 from a sealed position to access the interior space 108 of the base 102.

The design and construction of the lid 112 can vary from the above-described example and yet remain within the scope of the invention. The container 100 is durable, scratch-resistant, eco-friendly, and dishwasher safe.

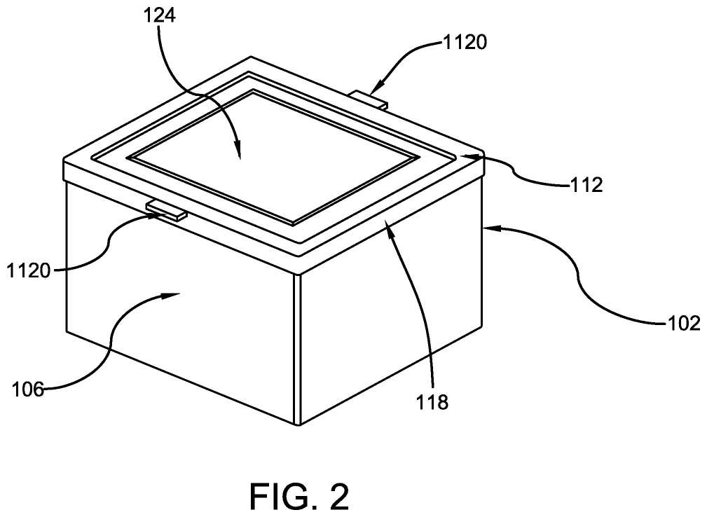

FIG. 2 illustrates a perspective view of the food storage container of FIG. 1 in accordance with the disclosed architecture. The lid 112 is configured to seal the base 102 with a skirt wall 118 circumscribing the top edge 110 of the base 102. The flange protrusions 1120 allow a user to easily remove the lid 112 from the base 102 without applying undue force. For securing the lid 112 on the base 102, a little pressure is applied on the lid 112 by a user allowing the skirt wall 118 to create the seal.

The top panel 124 is configured to protect the charcoal filter stored therein from outside elements and allows a user to remove and replace the filter as desired. It should be appreciated that the charcoal filter can last up to 90 days and is also configured to absorb ethylene gas released by fruits and vegetables stored in the container. The charcoal filter used in the container 100 can be made from coconut shells in one embodiment of the present invention.

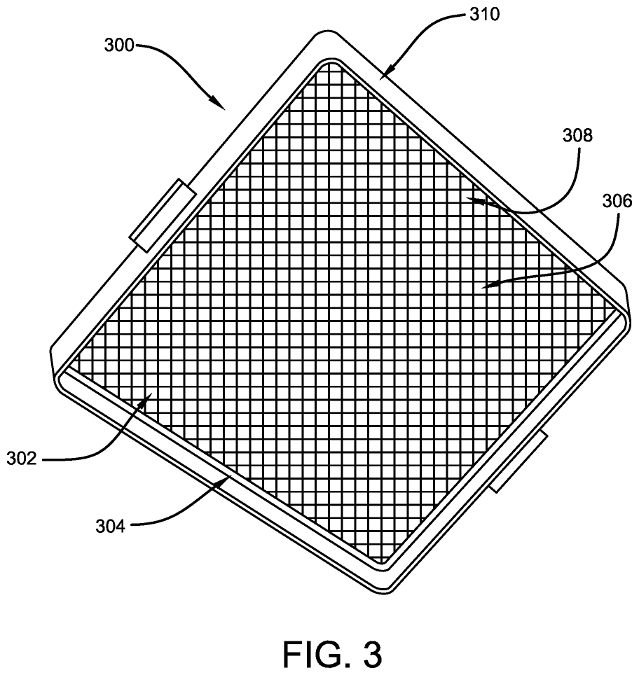

FIG. 3 illustrates a bottom perspective view of another embodiment of the lid used in the food storage container in accordance with the disclosed architecture. In the present embodiment, the bottom surface 302 of the lid 300 has a frame 304 along the circumference for removably securing a charcoal filter 306. The frame 304 has a continuous channel 308 for accommodating the filter 306, therein enabling the filter 306 to fully cover the bottom surface 302 of the lid 300.

In the present embodiment, the filter 306 has a size (i.e., an area) generally equal to the bottom surface 302 area, thereby providing maximum absorption of odor from the food stored in the container with which the lid 300 is used. Further, the top surface of the lid 300 can be transparent or opaque as per preferences of manufacturers and consumers.

It should be appreciated that the skirt wall 310 of the lid 300, when positioned on the base of a food storage container, seals the container without impacting, shrinking, or damaging the filter 306. The skirt wall 310 may have rubber affixed therein for creating a seal without damaging the filter 306 positioned on the bottom surface 302 of the lid 300.

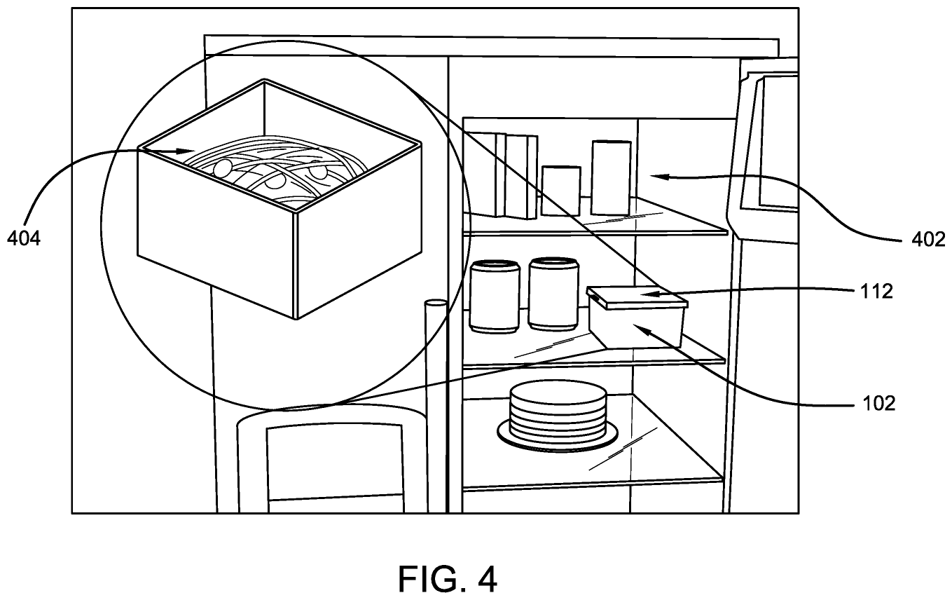

FIG. 4 illustrates a perspective view of the food storage container of FIG. 1 storing food in a refrigerator in accordance with the disclosed architecture. The storage containers of various embodiments of the present invention can be used with ovens, refrigerators, and freezers for maintaining freshness of stored food items. As illustrated, the food container 100 can be kept in a refrigerator 402 with the stored food item 404 sealed by the lid 112 allowing the container 100 to preserve the food 404, while the odor-resistant material of the base 102 and the charcoal filter prevent odor from being retained in the container 100, even when the food 404 is stored for a long time in the container 100. The container 100 can be used with any type of food item or beverage and can be used for heating or cooling the food item.

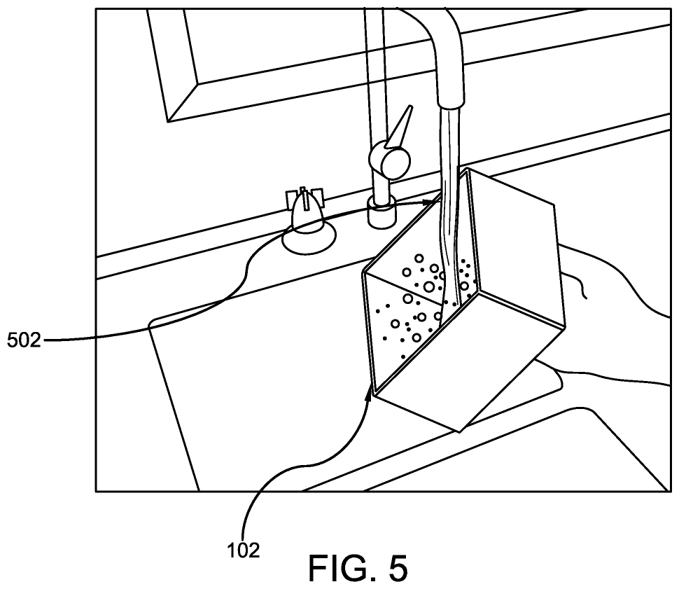

FIG. 5 illustrates the food container 100 of FIG. 1 being washed by a user for reuse in accordance with the disclosed architecture. The containers of various embodiments of the present invention, are dishwasher safe and can also be wiped and washed with water 502. As illustrated, the base 102 is washed with water to remove the stains that may have been caused by the stored food item. The lid, along with the charcoal filter, can also be washed with water or in a dishwasher enabling users to reuse the containers as per their preferences.

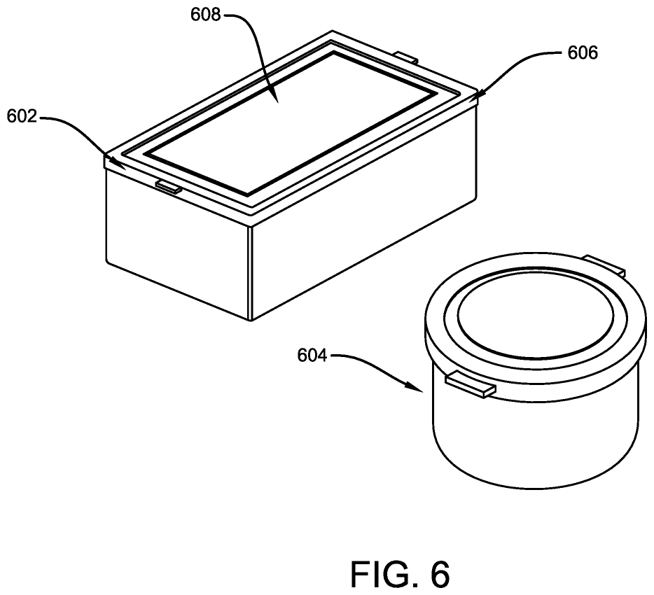

FIG. 6 illustrates a perspective view showing different embodiments of the food storage container of the present invention in accordance with the disclosed architecture. The food containers of the present invention can be designed in different sizes, shapes, designs, and colors to meet requirements of different users. The exemplary rectangular container 602 is made of odor-resistant material as described in FIG. 1 and the lid 606 has an embedded charcoal filter for filtering out the odor produced by stored food. The filter can be placed inside the panel 608, or alternatively along the bottom surface of the lid 606 as described in other embodiments of the present invention.

The exemplary round food container 604 has a rounded base and lid and it should be appreciated that other shapes and configurations of the containers are contemplated and fall within the scope of the invention without affecting the utility of the container.

It should be appreciated that the containers may have a removable tray to increase the storage capacity and the tray can be made of odor-resistant material. The containers of various embodiments can be formed from a clear, translucent, semi-transparent, or opaque material and can be formed in any desirable color.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “food storage container system”, “food container”, “multipurpose reusable food storage container”, “container”, and “storage container” are interchangeable and refer to the food storage container system 100, 602, 604 of the present invention.

Notwithstanding the foregoing, the food storage container system 100, 602, 604 of the present invention can be of any suitable size and configuration as is known in the art without affecting the overall concept of the invention, provided that it accomplishes the above-stated objectives. One of ordinary skill in the art will appreciate that the food storage container system 100, 602, 604 as shown in the FIGS. are for illustrative purposes only, and that many other sizes and shapes of the food storage container system 100, 602, 604 are well within the scope of the present disclosure. Although the dimensions of the food storage container system 100, 602, 604 are important design parameters for user convenience, the food storage container system 100, 602, 604 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A multipurpose reusable food storage container comprising:
a base having a bottom surface and a continuous sidewall, wherein said bottom surface and said continuous sidewall form an interior space for storing a food item;
wherein said continuous sidewall extends upwardly from a perimeter of said bottom surface and terminates at a top edge;
wherein said base is comprised of a food grade stainless steel or a glass;
a lid having a top surface, a bottom surface, and a skirt wall for covering said interior space of said base and for sealing around said top edge;
a cavity disposed in said lid;
a charcoal filter stored in said cavity; and
a top panel for covering said charcoal filter, wherein said top panel is selectively removable from said cavity.

2. The multipurpose reusable food storage container of claim 1, wherein said continuous sidewall is circumferential.

3. The multipurpose reusable food storage container of claim 2, wherein said glass is a high-grade UV glass.

4. The multipurpose reusable food storage container of claim 3, wherein said glass is oven safe.

5. The multipurpose reusable food storage container of claim 4, wherein said charcoal filter comprises a bed of activated carbon for absorbing an ethylene gas.

6. The multipurpose reusable food storage container of claim 5, wherein said top panel comprises a tab for engaging with an opening in said lid for removably fastening said top panel to said lid.

7. The multipurpose reusable food storage container of claim 6, wherein said lid comprises a plurality of flange protrusions for pulling said lid from said base.

8. The multipurpose reusable food storage container of claim 7, wherein said base is dishwasher safe.

9. A multipurpose reusable food storage container comprising:
a base having a bottom surface and a continuous sidewall, wherein said bottom surface and said continuous sidewall form an interior space for storing a food item;
wherein said continuous sidewall extends upwardly from a perimeter of said bottom surface and terminates at a top edge;
a lid having a top surface, a bottom surface, and a skirt wall for covering said interior space of said base and for sealing around said top edge of said base;
a cavity disposed in said lid;
a replaceable filter stored in said cavity; and
a top panel for covering said replaceable filter, wherein said top panel is selectively removable from said cavity.

10. The multipurpose reusable food storage container of claim 9, wherein said continuous sidewall is circumferential.

11. The multipurpose reusable food storage container of claim 9, wherein said base is comprised of a food grade stainless steel or a glass.

12. The multipurpose reusable food storage container of claim 9, wherein said replaceable filter comprises a plurality of coconut shells.

13. The multipurpose reusable food storage container of claim 11, wherein said glass is a high-grade UV glass.

14. The multipurpose reusable food storage container of claim 13, wherein said glass is oven safe.

15. The multipurpose reusable food storage container of claim 9, wherein said replaceable filter comprises a bed of activated carbon for absorbing an ethylene gas.

16. The multipurpose reusable food storage container of claim 9, wherein said top panel comprises a tab for engaging with an opening in said lid for removably fastening said top panel to said lid.

17. The multipurpose reusable food storage container of claim 9, wherein said lid comprises a plurality of flange protrusions for pulling said lid from said base.

18. A multipurpose reusable food storage container comprising:
a base having a bottom surface and a continuous sidewall, wherein said bottom surface and said continuous sidewall form an interior space for storing a food item;
wherein said continuous sidewall extends upwardly from a perimeter of said bottom surface and terminates at a top edge;
a lid having a top surface, a bottom surface, and a skirt wall for covering said interior space of said base and for sealing around said top edge of said base;
wherein said lid bottom surface comprises a frame for removably securing a replaceable charcoal filter; and
further wherein said replaceable charcoal filter comprises an area generally equal to an area of said lid.

19. The multipurpose reusable food storage container of claim 18, wherein said base is comprised of a food grade stainless steel or a glass.

20. The multipurpose reusable food storage container of claim 19, wherein said replaceable filter comprises a bed of activated carbon for absorbing ethylene gas.
